(19) United States
(12) Patent Application Publication
(10) Pub. No.: US 2020/0343517 A1
(43) Pub. Date: Oct. 29, 2020

(54) MULTI-LAYER CONTACT PLATE AND METHOD THEREOF

(71) Applicant: Tiveni MergeCo Inc., San Mateo, CA (US)

(72) Inventors: Heiner FEES, Bietigheim-Bissingen (DE); Andreas TRACK, Sachsenheim (DE); Ralf MAISCH, Abstatt (DE); Alexander EICHHORN, Eppingen (DE); Jörg DAMASKE, Freiberg (DE); Valentin BROKOP, Walheim (DE); Hans-Joachim PFLÜGER, Wüstenrot (DE); Claus Gerald PFLÜGER, Markgröningen (DE)

(21) Appl. No.: 16/850,980

(22) Filed: Apr. 16, 2020

Related U.S. Application Data
(60) Provisional application No. 62/837,545, filed on Apr. 23, 2019.

(51) Int. Cl. H01M 2/26

(52) U.S. Cl. CPC H01M 2/26

(57) ABSTRACT

An embodiment is directed to a method of fabricating a multi-layer contact plate, comprising providing a layer stack with first, second and third conductive layers, inserting brazing material into holes first and/or second conductive layers of a layer stack, and brazing the layer stack after the inserting. Another embodiment is directed to a multi-layer contact plate, comprising a layer stack with first, second and third conductive layers, with at least one inter-layer connection including a brazed area where the second conductive layer is brazed to each of the first and third conductive layers, and where the first and third conductive layers are directly brazed to each other through a hole in the second conductive layer.

### CROSS-REFERENCE TO RELATED APPLICATIONS

The present application for patent claims the benefit of U.S. Provisional Application No. 62/837,545 with attorney docket no. TIV-180012P1, entitled “MULTI-LAYER CONTACT PLATE AND METHOD THEREOF”, filed Apr. 23, 2019, which is assigned to the assignee hereof and hereby expressly incorporated by reference herein in its entirety.

### BACKGROUND

### 1. Field of the Disclosure

Embodiments relate to a multi-layer contact plate and method thereof.

### 2. Description of the Related Art

Energy storage systems may rely upon battery cells for storage of electrical power. For example, in certain conventional electric vehicle (EV) designs (e.g., fully electric vehicles, hybrid electric vehicles, etc.), a battery housing mounted into an electric vehicle houses a plurality of battery cells (e.g., which may be individually mounted into the battery housing, or alternatively may be grouped within respective battery modules that each contain a set of battery cells, with the respective battery modules being mounted into the battery housing). The battery modules in the battery housing are connected to a battery junction box (BJB) via busbars, which distribute electric power to an electric motor that drives the electric vehicle, as well as various other electrical components of the electric vehicle (e.g., a radio, a control console, a vehicle Heating, Ventilation and Air Conditioning (HVAC) system, internal lights, external lights such as head lights and brake lights, etc.).

### SUMMARY

An embodiment is directed to a method of fabricating a multi-layer contact plate, comprising providing a layer stack with first, second and third conductive layers, the second conductive layer being at least partially sandwiched between the first and third conductive layers, the layer stack including a gap through which the third conductive layer is partially exposed via an overlap between a first hole in the first conductive layer and a second hole in the second conductive layer, inserting brazing material into the first and second holes in the first and second conductive layers, and brazing the layer stack after the inserting.

Another embodiment is directed to a multi-layer contact plate, comprising a layer stack with first, second and third conductive layers, the second conductive layer being at least partially sandwiched between the first and third conductive layers, wherein the first, second and third conductive layers are mechanically and/or electrically connected to each other via a set of inter-layer connections, wherein at least one inter-layer connection among the set of inter-layer connections includes a brazed area where the second conductive layer is brazed to each of the first and third conductive layers, and wherein the brazed area is defined inside of first and second holes of the first and second conductive layers, respectively, the first and second holes overlapping at least in part.

### BRIEF DESCRIPTION OF THE DRAWINGS

A more complete appreciation of embodiments of the disclosure will be readily obtained as the same becomes better understood by reference to the following detailed description when considered in connection with the accompanying drawings, which are presented solely for illustration and not limitation of the disclosure, and in which:

FIG. 1 illustrates an example metal-ion (e.g., Li-ion) battery in which the components, materials, methods, and other techniques described herein, or combinations thereof, may be applied according to various embodiments.

FIG. 2 illustrates a high-level electrical diagram of a battery module that shows P groups 1 . . . N connected in series in accordance with an embodiment of the disclosure.

FIG. 3 illustrates a battery module during assembly after battery cells are inserted therein.

FIGS. 4A-4C illustrate the general arrangement of contact plate(s) with respect to battery cells of a battery module.

FIG. 5 illustrates an example of the layers of a conventional multi-layer contact plate.

FIG. 6 illustrates a contact plate arrangement for a battery module in accordance with an embodiment of the disclosure.

FIG. 7 illustrates a battery module that comprises the contact plate arrangement of FIG. 6.

FIG. 8 illustrates a contact plate configuration in accordance with an embodiment of the disclosure.

FIG. 9A illustrates an example of a layer stack with a complete or local surface brazing joint, whereby top and bottom layers sandwich a thinner layer in accordance with an embodiment of the disclosure.

FIG. 9B illustrates a layer stack of FIG. 9A further arranged with cutouts in accordance with an embodiment of the disclosure.

FIG. 10A illustrates an example whereby local tacks are added in gaps of the brazing layers to provide some fixation in accordance with an embodiment of the disclosure.

FIG. 10B illustrates an alternative example whereby the layer stack is pressed together via gravity force load by mounting a weighting mechanism onto the layer stack in accordance with an embodiment of the disclosure.

FIG. 10C illustrates an alternative example whereby the layer stack is pressed together via a compression (or spring) mechanism mounted onto the layer stack in accordance with an embodiment of the disclosure.

FIG. 11 illustrates a process of fabricating a multi-layer contact plate in accordance with an embodiment of the disclosure.

FIGS. 12A-12F perspectives of a layer stack during the fabrication process of FIG. 11 in accordance with embodiments of the disclosure.

FIGS. 13A-13E illustrate example embodiments depicting exemplary layer stacks before tacking and applying a brazing material (left side) and post-brazing (right side) in accordance with embodiments of the disclosure.

FIGS. 14A-14H illustrate further example embodiments depicting exemplary layer stacks in accordance with embodiments of the disclosure.

FIG. 15 illustrates examples of conductive layer holes (or cutouts) as variations VAR1 through VAR5 taken across cross-sections A-A and B-B of an exemplary layer stack with offset holes having the same critical dimension size in accordance with embodiments of the disclosure.

FIGS. 16A-16C illustrate alternative tacking/brazing configurations for exemplary layer stacks in accordance with embodiments of the disclosure.

### DETAILED DESCRIPTION

Embodiments of the disclosure are provided in the following description and related drawings. Alternate embodiments may be devised without departing from the scope of the disclosure. Additionally, well-known elements of the disclosure will not be described in detail or will be omitted so as not to obscure the relevant details of the disclosure.

Energy storage systems may rely upon batteries for storage of electrical power. For example, in certain conventional electric vehicle (EV) designs (e.g., fully electric vehicles, hybrid electric vehicles, etc.), a battery housing mounted into an electric vehicle houses a plurality of battery cells (e.g., which may be individually mounted into the battery housing, or alternatively may be grouped within respective battery modules that each contain a set of battery cells, with the respective battery modules being mounted into the battery housing). The battery modules in the battery housing are connected to a battery junction box (BJB) via busbars, which distribute electric power to an electric motor that drives the electric vehicle, as well as various other electrical components of the electric vehicle (e.g., a radio, a control console, a vehicle Heating, Ventilation and Air Conditioning (HVAC) system, internal lights, external lights such as head lights and brake lights, etc.).

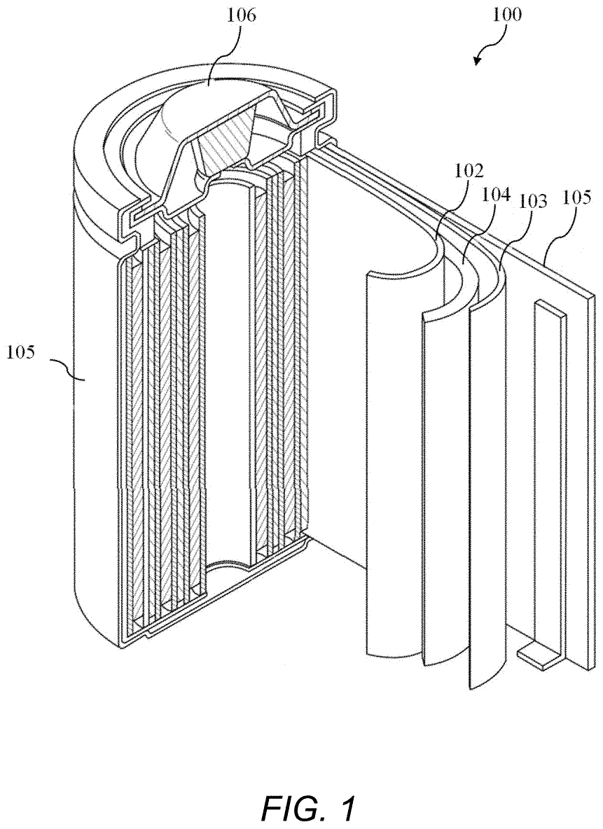

FIG. 1 illustrates an example metal-ion (e.g., Li-ion) battery in which the components, materials, methods, and other techniques described herein, or combinations thereof, may be applied according to various embodiments. A cylindrical battery cell is shown here for illustration purposes, but other types of arrangements, including prismatic or pouch (laminate-type) batteries, may also be used as desired. The example battery 100 includes a negative anode 102, a positive cathode 103, a separator 104 interposed between the anode 102 and the cathode 103, an electrolyte (shown implicitly) impregnating the separator 104, a battery case 105, and a sealing member 106 sealing the battery case 105.

Embodiments of the disclosure relate to various configurations of battery modules that may be deployed as part of an energy storage system. In an example, while not illustrated expressly, multiple battery modules in accordance with any of the embodiments described herein may be deployed with respect to an energy storage system (e.g., chained in series to provide higher voltage to the energy storage system, connected in parallel to provide higher current to the energy storage system, or a combination thereof).

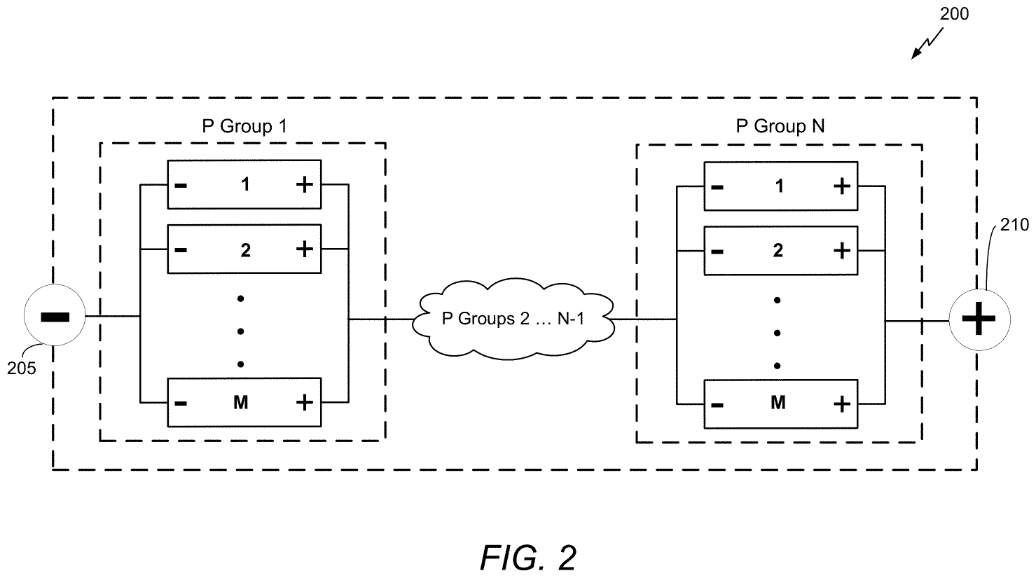

FIG. 2 illustrates a high-level electrical diagram of a battery module 200 that shows P groups 1 . . . N connected in series in accordance with an embodiment of the disclosure. In an example, N may be an integer greater than or equal to 2 (e.g., if N=2, then the intervening P groups denoted as P groups 2 . . . N−1 in FIG. 1 may be omitted). Each P group includes battery cells 1 . . . M (e.g., each configured as shown with respect to battery cell 100 of FIG. 1) connected in parallel. The negative terminal of the first series-connected P group (or P group 1) is coupled to a negative terminal 205 of the battery module 200, while the positive terminal of the last series-connected P group (or P group N) is connected to a positive terminal 210 of the battery module 200. As used herein, battery modules may be characterized by the number of P groups connected in series included therein. In particular, a battery module with 2 series-connected P groups is referred to as a “2S” system, a battery module with 3 series-connected P groups is referred to as a “3S” system, and so on.

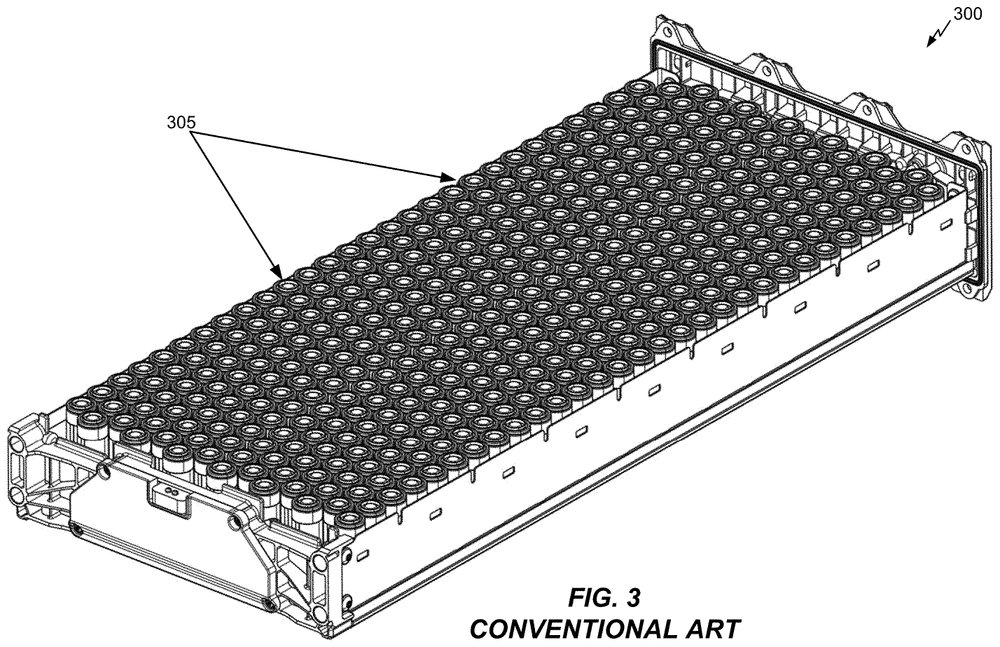

FIG. 3 illustrates a battery module 300 during assembly after battery cells 305 are inserted therein. In some designs, both the positive terminal (cathode) and negative terminal (anode) of the battery cells in the battery module 300 may be arranged on the same side (e.g., the top side). For example, the centered cell ‘head’ may correspond to the positive terminal, while the outer cell rim that rings the cell head may correspond to the negative terminal. In such a battery module, the P groups are electrically connected in series with each other via a plurality of contact plates arranged on top of the battery cells 305.

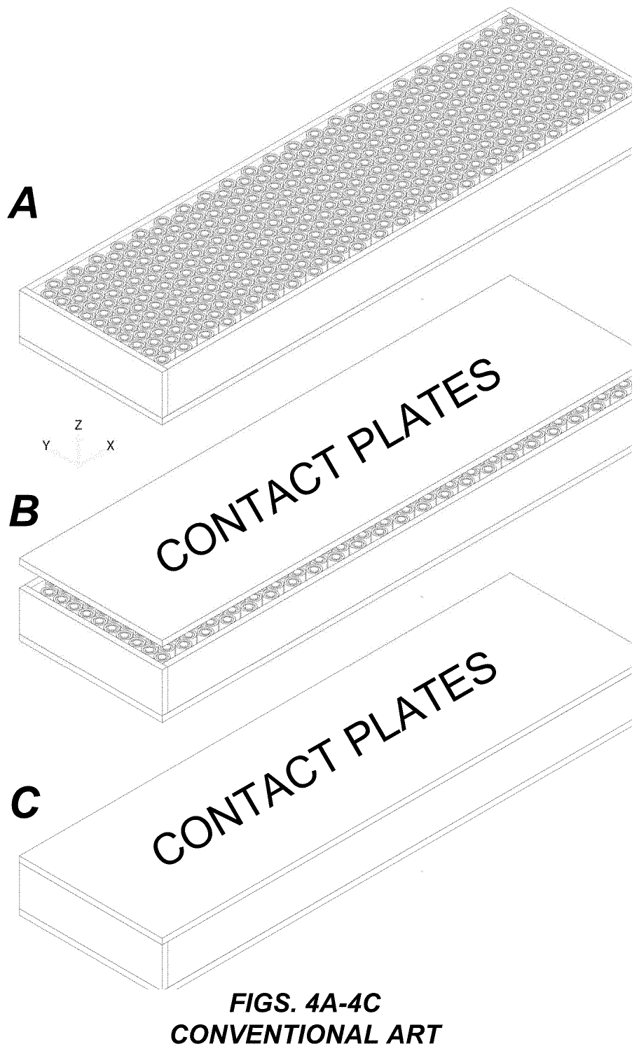

FIGS. 4A-4C illustrate the general arrangement of contact plate(s) with respect to battery cells of a battery module. As shown in FIGS. 4A-4C, the contact plates may be arranged on top of the battery cells in close proximity to their respective positive and negative terminals in some designs.

There are a variety of ways in which the above-noted contact plates may be configured. For example, the contact plates can be configured as solid blocks of aluminum or copper, whereby bonding connectors are spot-welded between the contact plates and the positive and negative terminals of the battery cells. Alternatively, a multi-layer contact plate that includes an integrated cell terminal connection layer may be used.

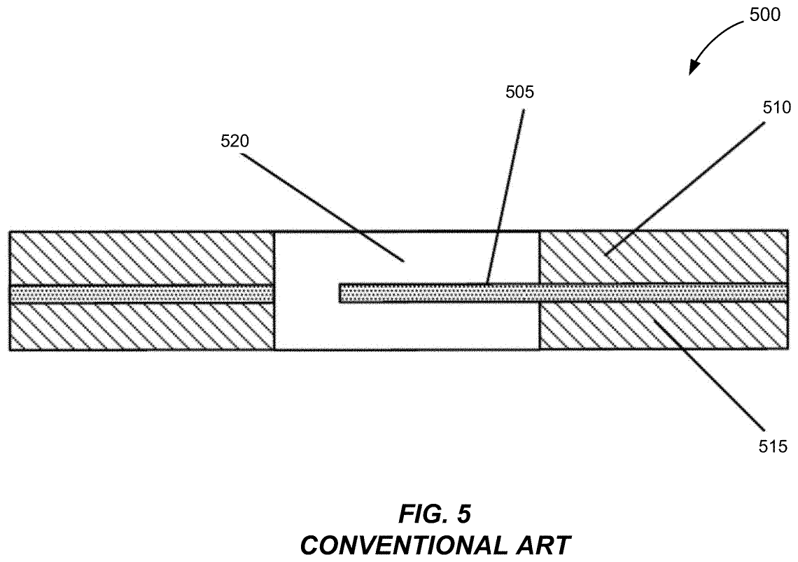

FIG. 5 illustrates an example of the layers of a conventional multi-layer contact plate 500. In FIG. 5, the multi-layer contact plate 500 includes a flexible cell terminal connection layer 505 that is sandwiched between a top conductive plate 510 and a bottom conductive plate 515. In an example, the top and bottom conductive plates 510 and 515 may be configured as solid Cu or Al plates (e.g., or an alloy of Cu or Al), while the flexible cell terminal connection layer 505 is configured as foil (e.g., steel or Hilumin foil). A number of openings, such as opening 520, are punched into the top and bottom conductive plates 510 and 515, while some part of the flexible cell terminal connection layer 505 extends out into the opening 520. During battery module assembly, the part of the flexible cell terminal connection layer 505 that extends into the opening 520 can then be pressed downward so as to contact a positive or negative terminal of one or more battery cells arranged underneath the opening 520, and then welded to obtain a mechanically stable plate-to-terminal electrical connection.

Referring to FIG. 5, the layers of the multi-layer contact plate 500 may be joined via soldering or brazing (e.g., based on soldering or brazing paste being arranged between the respective layers before heat is applied), which results in soldering or brazing “joints” between the respective layers. These joints provide both (i) an inter-layer mechanical connection for the multi-layer contact plate 500, and (ii) an inter-layer electrical connection for the multi-layer contact plate 500.

Referring to FIG. 5, one of the advantages of configuring the flexible cell terminal connection layer 505 with a different material (e.g., steel or Hilumin) than the surrounding top and bottom conductive plates 510 and 515 (e.g., Cu, Al, or an alloy thereof) is so that the cell terminal connections can be welded via like metals. For example, it is common for cell terminals to be made from steel or Hilumin. However, steel is not a particularly good conductor. Hence, the top and bottom conductive plates 510 and 515 are made from a more conductive material (e.g., Cu, Al, or an alloy thereof) than steel, while steel is used in the flexible cell terminal connection layer 505 to avoid disparate metals being welded together for the cell terminal connection.

In an alternative embodiment to the contact plate configuration depicted in FIG. 5, instead of two solid plates sandwiching a foil terminal connection layer, a contact plate (e.g., Cu, Al, or an alloy thereof, although it is possible for the contact plate to be multi-layer) can be coated with a thin layer of a different metal (e.g., steel or Hilumin) that is suitable to be welded to one or more battery cell terminals. The coated contact plate can be locally punched or etched to define specific sections that (i) can be moved flexibly, or (ii) can be configured as a fuse, or (iii) can be made suitable for welding to the battery cell terminal(s).

In yet alternative embodiment to the contact plate configuration depicted in FIG. 5, instead of two solid plates sandwiching a foil terminal connection layer, a contact plate may comprise a busbar (e.g., a single-layer or solid block or plate of Cu, Al, or an alloy thereof), with respective bonding connectors being attached or affixed (e.g., via welding, tacking, etc.) to sidewall(s) of the busbar.

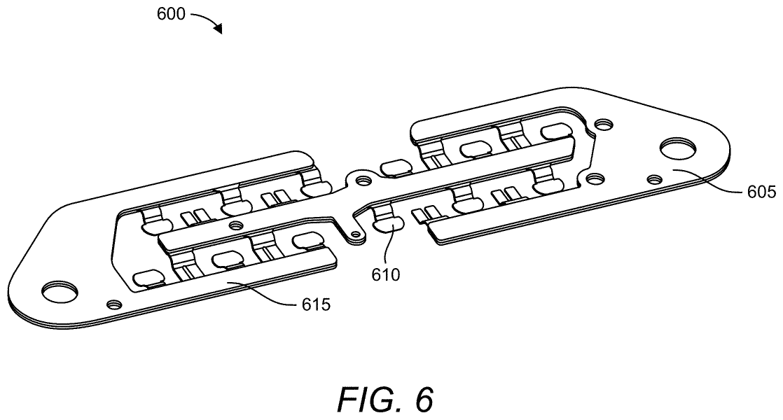

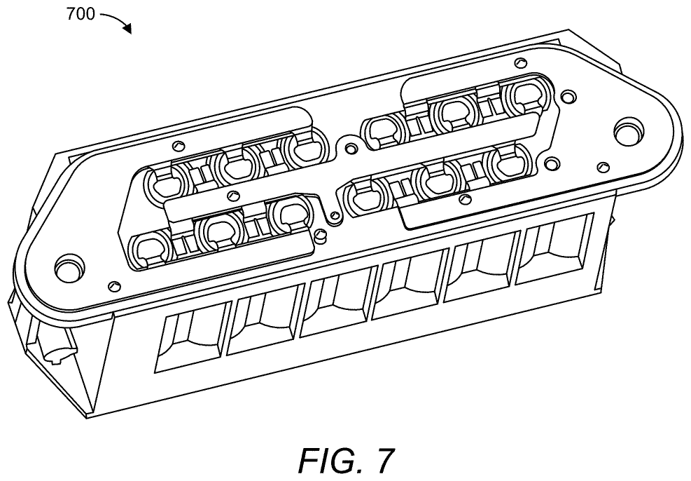

FIG. 6 illustrates a contact plate arrangement 600 for a battery module in accordance with an embodiment of the disclosure. The contact plate arrangement 600 is configured with single-level contact plate configuration. In the example of FIG. 6, each respective contact plate may be configured as the multi-layer contact plate 500 (e.g., top/bottom plates sandwiching a flexible cell terminal connection layer). As used herein, contact plates being arranged in a single-level means that the contact plates do not overlap (or stack) with each other, and thereby do not require ‘vertical’ electrical insulation layers (although insulation may be arranged to provide ‘horizontal’ electrical insulation). In particular, the contact plate arrangement 600 includes a “negative pole” contact plate 605, a “center” contact plate 610, and a “positive pole” contact plate 615. The contact plate arrangement 600 is configured to chain two distinct P-Groups (i.e., distinct parallel groups of battery cells as described above with respect to FIG. 2) together in series. To this end, the “negative pole” contact plate 605 includes a set of negative bonding connectors for connecting to a set of negative cell terminals of P-Group 1, the “center” contact plate 610 includes a set of positive bonding connectors for connecting to a set of positive cell terminals of P-Group 1 as well as a set of negative bonding connectors for connecting to a set of negative cell terminals of P-Group 2, and the “positive pole” contact plate 615 includes a set of positive bonding connectors for connecting to a set of positive cell terminals of P-Group 2. FIG. 7 illustrates a battery module 700 that comprises the contact plate arrangement 600 of FIG. 6.

In the embodiment of FIGS. 6-7, the contact plate arrangement 600 connects a total of 12 battery cells together, with 6 battery cells per P-Group. In an example, the contact plates 605-615 may be arranged as multi-layer contact plates (e.g., top/bottom plates made from Aluminum sandwiching a steel layer (Hilumin), with each multi-layer contact plate having a total thickness of about 1.8 mm).

For multi-layer contact plates, an important design characteristic is that each layer (e.g., Al, Hilumin or steel, Cu, etc.) be connected to one or more other layers both mechanically (e.g., to ensure that the layers will not separate during operation) and electrically (e.g., to ensure sufficient inter-layer conductivity). In some embodiments, these inter-layer connections may be characterized as primary inter-layer connections which provide both an inter-layer mechanical connection and an inter-layer electrical connection, and secondary inter-layer connections that primarily provide an inter-layer mechanical connection only (although some enhanced conductivity across these connections is possible). To put another way, the secondary inter-layer connections are associated with higher electrical resistance as compared to the primary inter-layer connections. In some designs, different brazing materials may be used in association with formation of the primary inter-layer connections as compared to formation of the secondary inter-layer connections (e.g., the brazing material used for the primary inter-layer connections may be more conductive, etc.). In other designs, the same brazing material may be used in association with formation of the primary inter-layer connections and the secondary inter-layer connections.

For example, the primary inter-layer connections may be designed so as to ensure a good current flow between layers of different types (e.g., from the Hilumin to the aluminum layers). While described above as providing both an inter-layer mechanical connection and an inter-layer electrical connection, in some designs the mechanical properties of the primary inter-layer connections are nominal. For example, for some applications, it may be sufficient for the primary inter-layer connections to provide a good electrical connection irrespective of a degree to which these connections strengthen the inter-layer mechanical bonding or adhesion The secondary layer connections by contrast may ensure the mechanical connection between the layers, e.g., especially in areas where no electrical connection of a cell-tap is needed. In some designs, due to manufacturing restrictions, the same brazing alloy/brazing paste/brazing process may be used for both the primary and secondary inter-layer connections. However, in other applications the secondary inter-layer connections can be made before the brazing process and then the mechanical joints (or secondary inter-layer connections) can be made by a different process, for instance by laser welding.

In an example where two layers of aluminum sandwich an inner layer of steel, the conductivity of the steel or Hilumin layer is poor in comparison to the aluminum layer (although the steel layer may still be characterized as a conductive layer, as at least part of the steel layer is configured to conduct current, in particular the bonding connector part). In this case, current flowing from steel bonding connectors into the contact plate to jump from the steel bonding connectors into the top/bottom aluminum layers. So, except for the current flowing across the steel bonding connectors themselves, a relatively small amount of current flows across the steel layer separate from its bonding connector part. In some applications, a primary inter-layer connection may be defective, whereby the steel layer is only electrically connected to one of the top/bottom aluminum layers. In this case, a localized imbalance may occur whereby the current from the bonding connector will most jump to only one of the aluminum layers (i.e., the aluminum layer which has the better electrical connection at that particular primary inter-layer connection). However, as the imbalanced current flows across the contact plate and reaches a next primary inter-layer connection which is not defective in this manner, the current may then split or equalize across the two aluminum layers. While described with respect to steel and aluminum layers in this paragraph, it will be appreciated that these basic concepts in terms of current flow also apply to layers made from other material compositions.

In some designs, the brazing alloy used for the primary inter-layer connections need not be particularly electrically conductive (although an electrically conductive brazing alloy can certainly be used if available). As an example, the thickness of the brazing alloy part of the primary inter-layer connection may be very low, e.g., in the range of the air gap. Due to this low thickness, the resistance is also very low, and the brazing alloy used for the primary inter-layer connections need not be particularly electrical conductive.

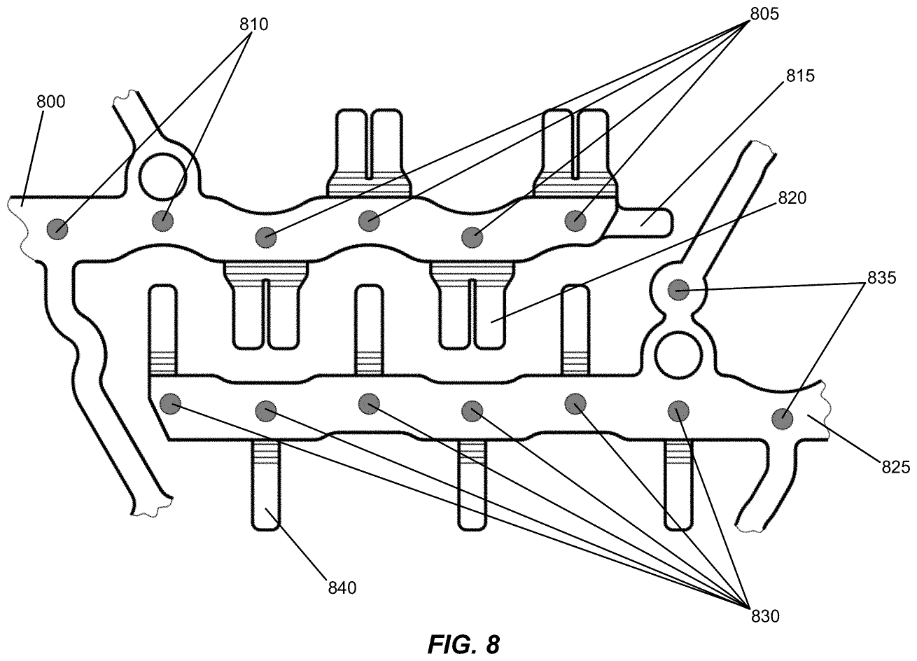

FIG. 8 illustrates a contact plate configuration in accordance with an embodiment of the disclosure. In FIG. 8, contact plate section 800 is configured as a multi-layer contact plate arranged with a plurality of primary inter-connections 805 (i.e., each providing a combination of an inter-layer mechanical connection and an inter-layer electrical connection) and a plurality of secondary inter-layer connections 810 (e.g., each providing primarily an inter-layer mechanical connection). In this embodiment, the contact plate section 800 is also arranged with a voltage measurement connection tap 815 (e.g., which may be coupled to a sensor for voltage monitoring). The contact plate section 805 is also arranged with a plurality of negative pole connection taps 820 (or bonding connectors) that may each be welded to one or more negative terminals of battery cells (not expressly shown in FIG. 8) arranged underneath the contact plate section 800. In some examples, the negative pole connection taps may a part of a non-sandwiched protrusion of a ‘sandwiched’ layer (e.g., made from Hilumin) of the contact plate section 800.

Referring to FIG. 8, contact plate section 825 is configured as a multi-layer contact plate arranged with a plurality of primary inter-layer connections 830 (i.e., each providing a combination of an inter-layer mechanical connection and an inter-layer electrical connection) and a plurality of secondary inter-layer connections 835 (e.g., each providing primarily an inter-layer mechanical connection). The contact plate section 825 is also arranged with a plurality of positive pole connection taps 840 (or bonding connectors) that may each be welded to a positive terminal of a battery cell (not expressly shown in FIG. 8) arranged underneath the contact plate section 825. In some examples, the positive pole connection taps may be a part of a non-sandwiched protrusion of a ‘sandwiched’ layer (e.g., made from Hilumin) of the contact plate section 825.

There are various ways in which the primary and secondary inter-layer connections may be formed, including:
A complete or local surface brazing joint,
A cutout in one or more layers (e.g., an outer layer made from a conductive material such as aluminum, and inner layer made from a less electrically conductive material such as steel or Hilumin, or a combination thereof) for application of brazing paste, and/or
A cutout in one or more layers (e.g., an outer layer made from a conductive material such as aluminum, and inner layer made from a less electrically conductive material such as steel or Hilumin, or a combination thereof) for draining gas out of the brazing gap during brazing.

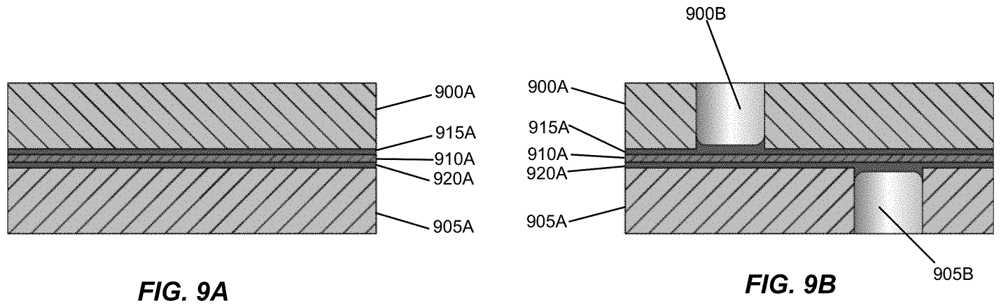

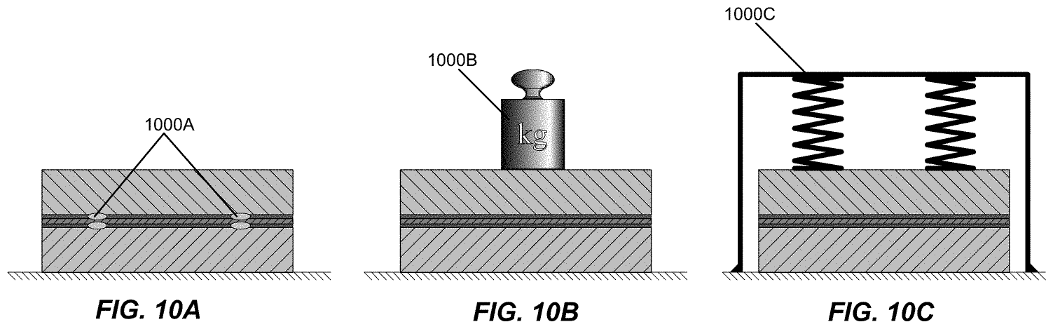

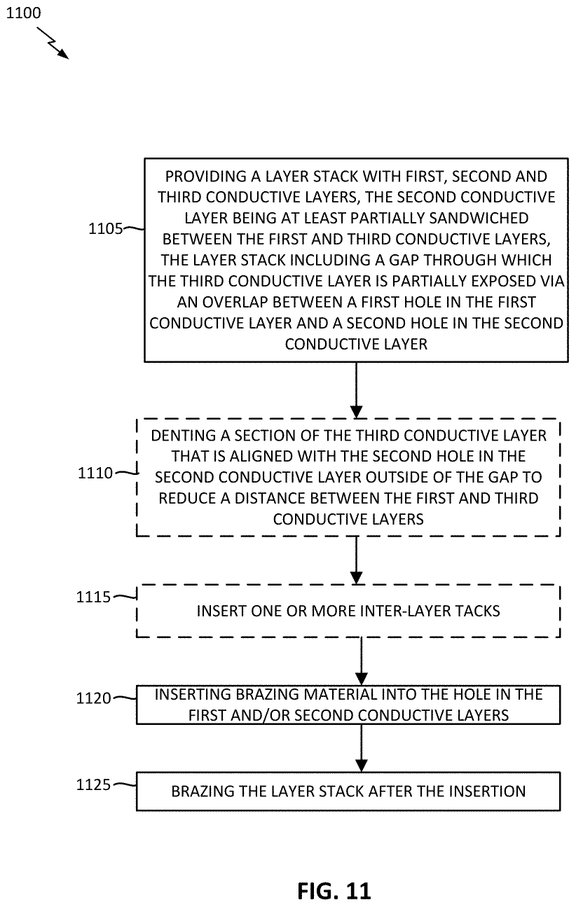

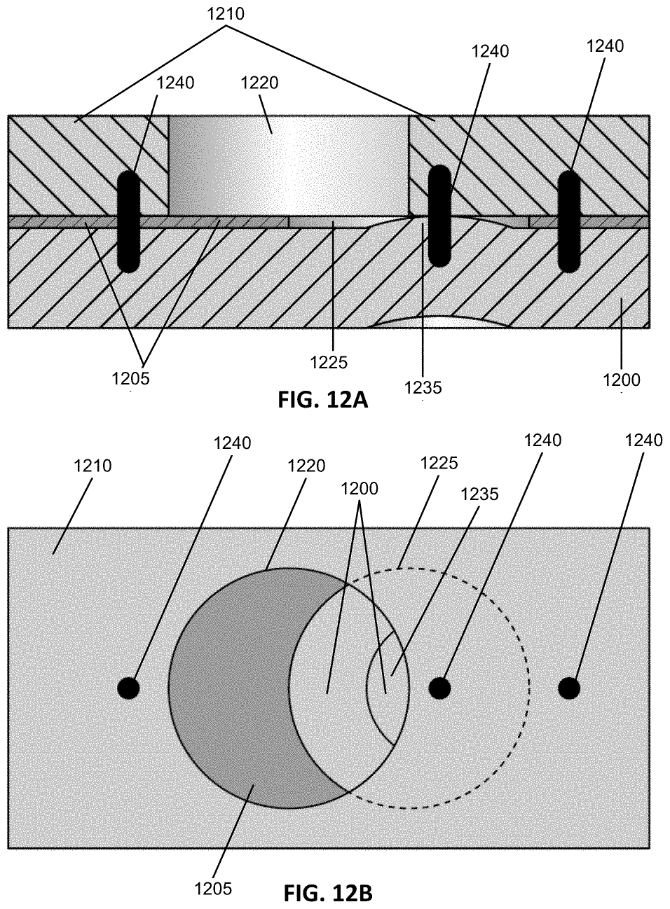

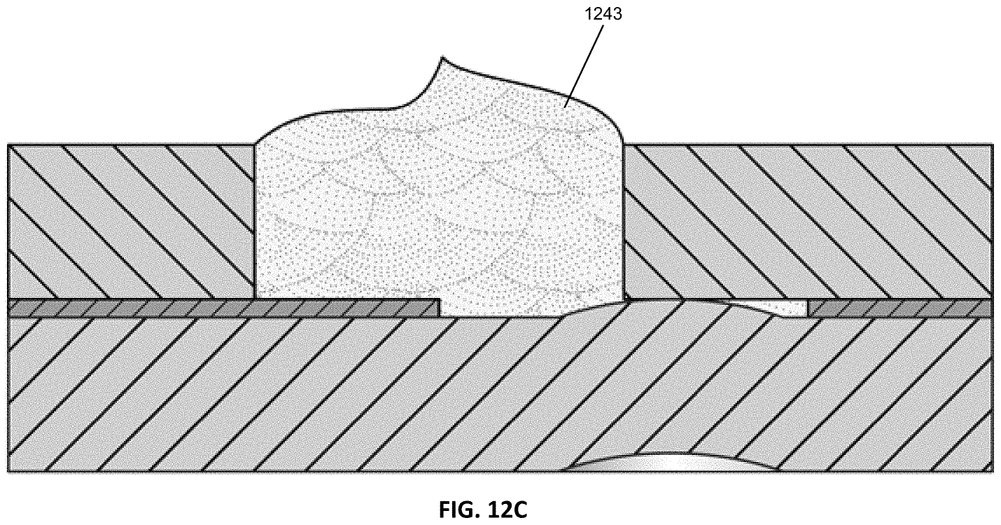

FIG. 9A illustrates an example of a layer stack with a complete or local surface brazing joint, whereby top and bottom layers (e.g., Al layers) 900A and 905A sandwich a thinner layer 910A (e.g., a Hilumin layer). Layers 915A and 920A of brazing alloy are arranged between the sandwiched layer 910A and the top and bottom layers 900A and 905A. Hence, when the layer stack is passed through a brazing device (e.g., a furnace) while the layer stack is secured with a clamping device (e.g., to establish a brazing gap with a desired thickness and to keep the brazing gap at the connection points in parallel, as discussed in more detail below with respect to FIGS. 10A-10C, an inter-layer connection is formed as the brazing alloy is melted.

FIG. 9B illustrates a layer stack of FIG. 9A further arranged with cutouts 900B and 905B. As noted above, the cutouts 900B and 905B may be added to permit application of brazing paste and/or to permit venting of gas during brazing.

In further embodiments, various mechanisms may be used to hold the various layers of the layer stack together prior to and during the brazing, as shown in FIGS. 10A-10C.

FIG. 10A illustrates an example whereby local tacks 1000A are added in gaps of the brazing layers to provide some fixation. In an example, the local tacks 1000A may be made a part of one or more of the layers of the layer stack which undergo a tacking process such as mechanical crimping, spot welding, laser welding, etc. One advantage to this approach is that an independent clamping mechanism need not be used to hold the layers together in some implementations.

FIG. 10B illustrates an alternative example whereby the layer stack is pressed together via gravity force load by mounting a weighting mechanism 1000B onto the layer stack. Disadvantages to this approach is that the weighting mechanism 1000B should preferably distribute weight evenly across the layer stack which may be somewhat difficult, and the weighting mechanism 1000B itself will heat up during the brazing (which is inefficient in terms of energy consumption). In FIG. 10B, the weighting mechanism 1000B is denoted as ‘kg’ to indicate its gravity-based function, and not to characterize the amount of weight of the weighting mechanism 1000B.

FIG. 10C illustrates an alternative example whereby the layer stack is pressed together via a compression (or spring) mechanism 1000C mounted onto the layer stack. Disadvantages to this approach are generally cost related in that specialized springs may be needed to achieve high precision, and multiple parts are required.

Embodiments of the present disclosure are directed to a multi-layer contact plate with one or more inter-layer connections formed via a brazed section where top and bottom conductive layers are mechanically and/or electrically connected to an intermediate (or sandwiched) conductive layer while also being mechanically and/or electrically connected to each other through a gap in the intermediate conductive layer.

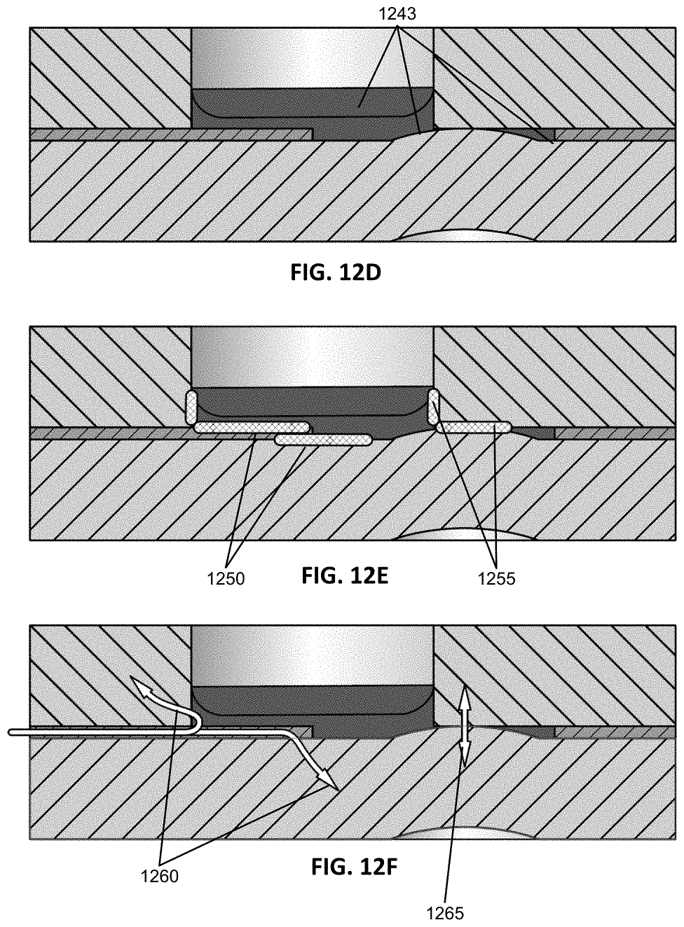

FIG. 11 illustrates a process 1100 of fabricating a multi-layer contact plate in accordance with an embodiment of the disclosure.

Referring to FIG. 11, at 1105, a layer stack is provided. The layer stack is arranged with first, second and third conductive layers, the second conductive layer being at least partially sandwiched between the first and third conductive layers. The layer stack includes a gap through which the third conductive layer is partially exposed via an overlap between a first hole in the first conductive layer and a second hole in the second conductive layer. In an example, the respective holes are offset from each other so as to overlap only in part. In a further example, the respective holes may be configured as circular cutouts in the respective conductive layers, although in other aspects non-circular shapes may be used for either hole. In an example, the respective holes may be defined in the respective conductive layers before the layer stack is assembled (e.g., by pre-stamping the respective conductive layers).

At 1110, a section of the third conductive layer that is aligned with the second hole in the second conductive layer is optionally dented outside of the gap to reduce a distance between the first and third conductive layers. In an example, it is also possible for the third conductive layer to be dented inside of the gap as well (at least in part). In an example, the optional denting at 1110 may be based on force applied in a direction from the third conductive layer towards the first conductive layer which causes the third conductive layer to push through the second conductive layer so as to directly contact the first conductive layer. In a specific example, the optional denting at 1110 can be skipped if laser welding is used for brazing the layer stack at 1125 (discussed below in more detail). At 1115, one or more inter-layer mechanical tacks are optionally inserted at one or more locations to improve inter-layer fixation. As will be described below in more detail, these inter-layer mechanical tacks can be punched through any combination of two or more of the first, second and third conductive layers.

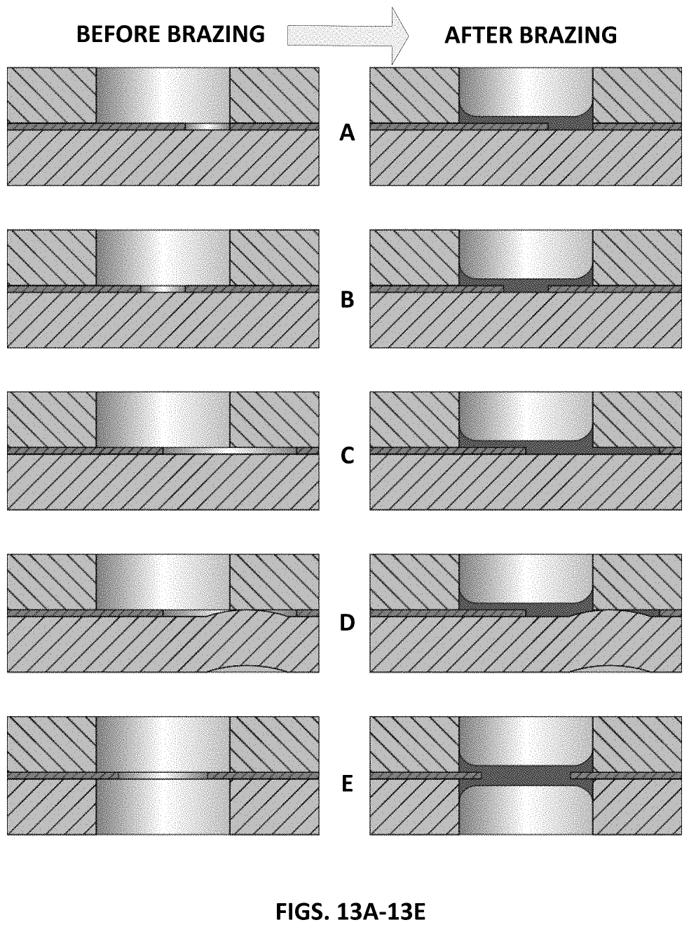

FIGS. 12A-12B illustrate a side-perspective and a top-perspective of the layer stack after 1105 and optional 1110-1115 are performed (before brazing) in accordance with an embodiment of the disclosure. In particular, the layer stack of FIGS. 12A-12B depicts a first conductive layer 1200, a second conductive layer 1205 and a third conductive layer 1210. A circular hole 1220 is defined in the third conductive layer 1210, which exposes part of the second conductive layer 1205 as shown in FIG. 12B. A circular hole 1225 is defined in the second conductive layer 1205. In an example, the circular holes 1220 and the 1225 may function as a gas vent during brazing. As shown, the circular holes 1220 and 1225 are offset from each other while also overlapping in part, with an overlapped portion (or gap) exposing the first conductive layer 1200. Part of an optional dented portion of the first conductive layer 1200 is shown at 1235. In this embodiment, the optional dented portion 1235 of the first conductive layer 1200 contacts the underside of the third conductive layer 1210 through the circular hole 1225, although it will be appreciated that this contact can alternatively occur at any point inside of the circular hole 1225 that does not overlap with the circular hole 1220. Optional mechanical tacks 1240 are also shown.

Turning back to FIG. 11, at 1120, a brazing material (e.g., a brazing fillet or brazing alloy) is inserted into the first and second holes in the first and/or second conductive layers. FIG. 12C illustrates the layer stack from FIG. 12A after the insertion of brazing material 1243 (before brazing). At 1125, the layer stack is brazed after the insertion of 1120. FIG. 12D illustrates the layer stack of FIG. 12C after brazing. In an example, the brazing of 1125 may be implemented via inductive heat applied to the layer stack via a furnace, although in other embodiments the layer stack can instead be applied with inductive heat via other mechanism(s) (e.g., application of an electric current, etc.). As shown in FIG. 12E, the brazing results in a first brazed section 1250 where the second conductive layer becomes mechanically and electrically connected to the first and third conductive layers, and a second brazed section 1255 where the first and third conductive layers are more directly connected mechanically and electrically (e.g., without the second conductive layer as an intervening layer). FIG. 12F depicts arrows that show the flow of current during module operation (post-brazing once the layer stack) is deployed as a multi-layer contact plate. As shown in FIG. 12F, current flows both between the second conductive layer and each of the first and third conductive layers, and may also flow directly between the first and third conductive layers. In particular, current flow 1260 corresponds to current from/to the cell connection tap (e.g., because the sandwiched layer may be used as the bonding connector to the cell terminals) while the current flow 1265 is the ‘internal’ current flow of the multi-layer contact plate for voltage equalization between the first and third conductive layers.

The aforementioned multi-layer contact plate and fabrication techniques may provide one or more advantages over the techniques described with respect to FIGS. 9A-10C, including:
Defining inter-layer connection areas via conductive layer holes (or cutouts),
Direct brazing of top/bottom (or first/third) conductive layers (e.g., aluminum to aluminum in some designs),
Inter-layer connections that facilitate both mechanical and electrical inter-layer connections,
Defined ignition points for brazing,
Formation of a brazing fillet that is form-fit to the brazing area (e.g., that fits snugly into the hole(s) of the conductive layers),
A vending duct (e.g., the hole(s) of the conductive layers) to ensure a high quality brazing connection (low porosity),
Simple application of brazing paste,
Reservoir for brazing paste (e.g., to prevent overflow), and
Mechanical tacking can be used to avoid complex and uneconomic brazing device (e.g., an independent clamping mechanism).

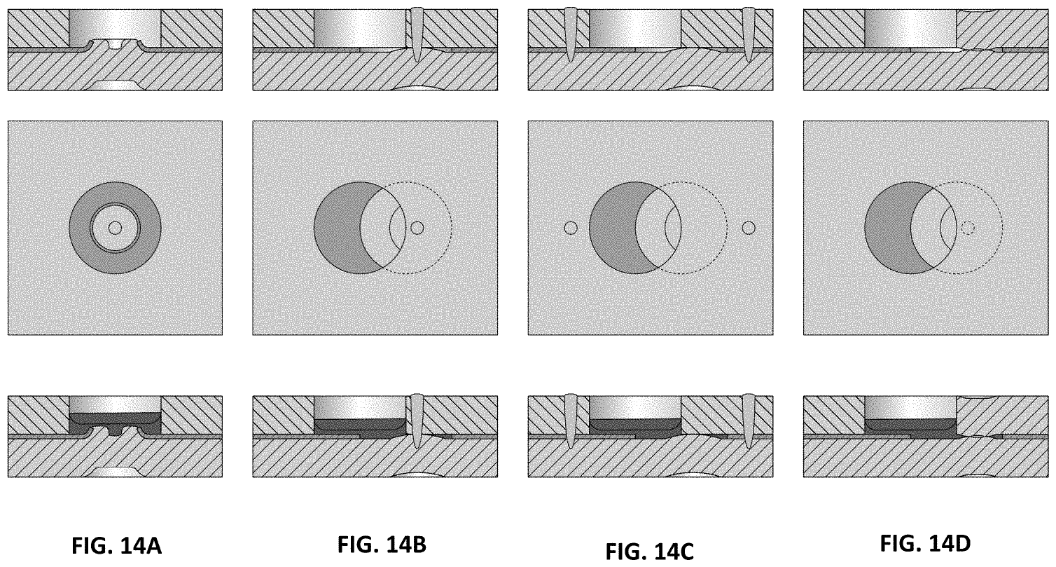

FIGS. 13A-13E illustrate example embodiments depicting exemplary layer stacks before applying a brazing material (left side) and post-brazing (right side). Each of FIGS. 13A-13E represents a different example implementation of a layer stack processed in accordance with an example embodiment of FIG. 11. In FIGS. 13A-13E, the layer orientation is inverted such that the top-most conductive layer in FIGS. 13A-13E corresponds to the bottom-most conductive layer in FIGS. 9A-10C and 12A-12F, and the bottom-most conductive layer in FIGS. 13A-13E corresponds to the top-most conductive layer in FIGS. 9A-10C and 12A-12F. While the various embodiments depicted in FIGS. 13A-13E are shown without dents in the top-most or bottom-most conductive layers, in other embodiments dents may optionally be added to one or both of these layers. Further, in some designs, tacking may optionally be used to further strengthen the inter-layer connections depicted in FIGS. 13A-13E. In other designs, denting and tacking may be implemented in combination (e.g., as in FIG. 12A for instance), while in yet other designs, neither denting nor tacking may be used for the inter-layer connections depicted in FIGS. 13A-13E.

Referring to FIG. 13A, holes in the first and second conductive layers are arranged with different diameters. In the example of FIG. 13A, the hole in the second conductive layer overlaps completely with the hole in the first conductive layer. Brazing material may be inserted on one side of layer stack through the respective hole/-s in the first and/or second conductive layers. In FIG. 13A, the respective holes in the first and second conductive layers are offset from each other in the sense that each respective hole has a different center point.

Referring to FIG. 13B, holes in the first and second conductive layers are arranged with different diameters. In the example of FIG. 13B, the hole in the second conductive layer overlaps completely with the hole in the first conductive layer. Brazing material may be inserted on one side of layer stack through the respective hole/-s in the first and/or second conductive layers. In FIG. 13B, the respective holes in the first and second conductive layers are not offset from each other in the sense that each respective hole has the same center point.

Referring to FIG. 13C, holes in the first and second conductive layers are arranged with the same diameter. In the example of FIG. 13C, the hole in the second conductive layer overlaps only partially with the hole in the first conductive layer. Brazing material may be inserted on one side of layer stack through the respective hole/-s in the first and/or second conductive layers. In FIG. 13C, the respective holes in the first and second conductive layers are offset from each other in the sense that each respective hole has a different center point.

FIG. 13D illustrates a layer stack configuration that is similar to the layer stack configuration depicted in FIG. 13C except that the third conductive layer includes a dented portion to facilitate a direct brazing inter-layer connection between the first and third conductive layers.

Referring to FIG. 13E, holes in the first and third conductive layers are arranged with the same diameter (no offset), while a hole with a smaller diameter is arranged in the second conductive layer. In the example of FIG. 13E, the hole in the second conductive layer overlaps completely with the holes in the first and third conductive layers. Brazing material may be inserted on both sides of the layer stack through the respective holes in the first, second and third conductive layers. In FIG. 13E, the respective holes in the first and second conductive layers are not offset from each other in the sense that each respective hole has the same center point.

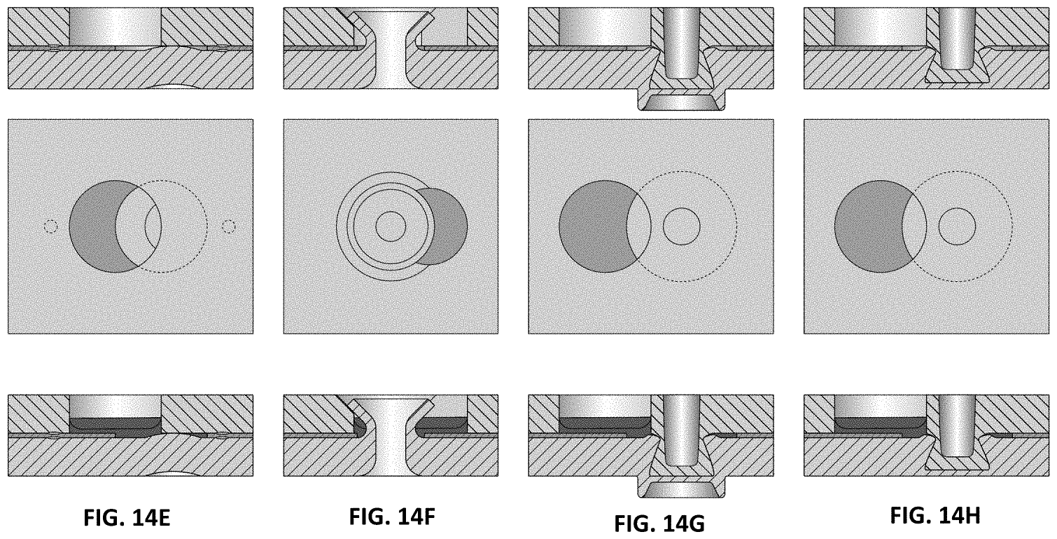

FIGS. 14A-14H illustrate further example embodiments depicting exemplary layer stacks in accordance with embodiments of the disclosure. Each of FIGS. 14A-14H represents a different example tacking implementation of a layer stack processed in accordance with an example embodiment of FIG. 11. In each of FIGS. 14A-14H, a side-perspective and a top-perspective of a layer stack configuration before brazing is shown at top and middle, respectively, while a side-perspective of the layer stack configuration after brazing is shown at bottom.

As shown in FIG. 14A, the third conductive layer is configured to crimp the second conductive layer. As shown in FIG. 14B, laser tacking is implemented between the first and third conductive layers. As shown in FIG. 14C, laser tacking is implemented between the first, second and third conductive layers. As shown in FIG. 14D, spot-welding tacking is implemented between the first and third conductive layers. As shown in FIG. 14E, spot-welding tacking is implemented between the first and second conductive layers and between the second and third conductive layers. As shown in FIG. 14F, a ‘tulip’ shaped hole is defined in the third conductive layer for tacking the first and third conductive layers. In FIG. 14G, punch-press tacking (e.g., TOX Round Joints, whereby a round punch presses materials to be joined by a die cavity) is implemented between the first and third conductive layers. In FIG. 14H, tacking by flat tox tacking by tox is implemented between the first and third conductive layers.

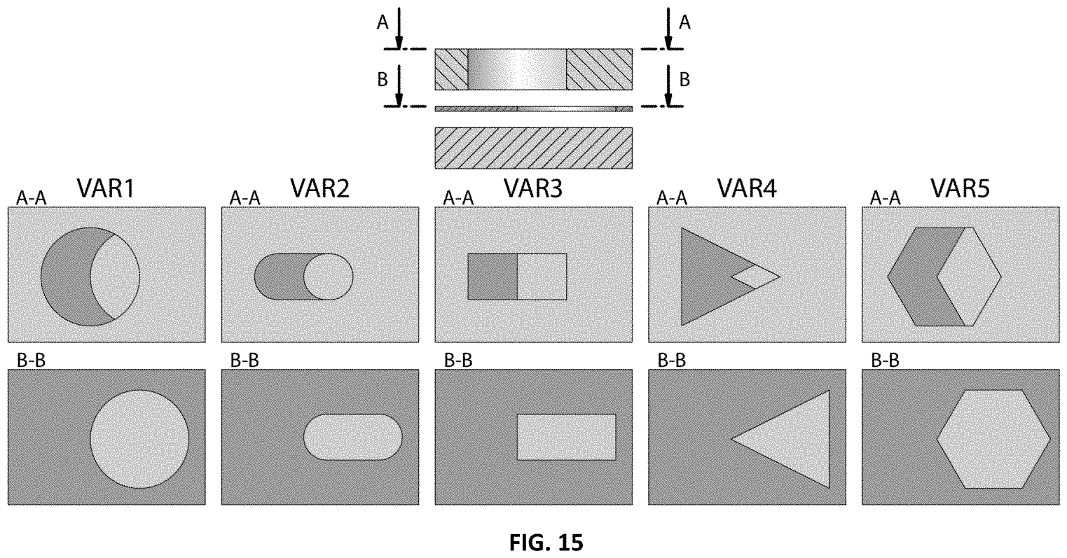

While many of the examples described above depict conductive layer holes (or cutouts) arranged in a circular shapes, many different hole shapes are possible in other implementations. A few non-limiting examples of conductive layer holes (or cutouts) are depicted in FIG. 15 as variations VAR1 through VAR5 taken across cross-sections A-A and B-B of an exemplary layer stack with offset holes having the same critical dimension size (e.g., the same diameter for circular-holes, the same length for rectangular holes, etc.). For example, VAR1 depicts an offset arrangement of circular holes, VAR2 depicts an offset arrangement of pill-shaped holes, VAR3 depicts an offset arrangement of rectangular-shaped holes, VAR4 depicts an offset arrangement of triangular-shaped holes, and VAR5 depicts an offset arrangement of hexagonal-shape holes. Other shapes may also be used in yet other embodiments. Also, as noted above, the holes in other embodiments need not be offset from each other, and may also differ in terms of critical dimension size (e.g., the different diameters for circular-holes, the different lengths for rectangular holes, etc.). In yet other embodiments, mismatched shapes can be used (e.g., a rectangular cutout in the first conductive layer can overlap with a circular cutout in the second conductive layer, etc.).

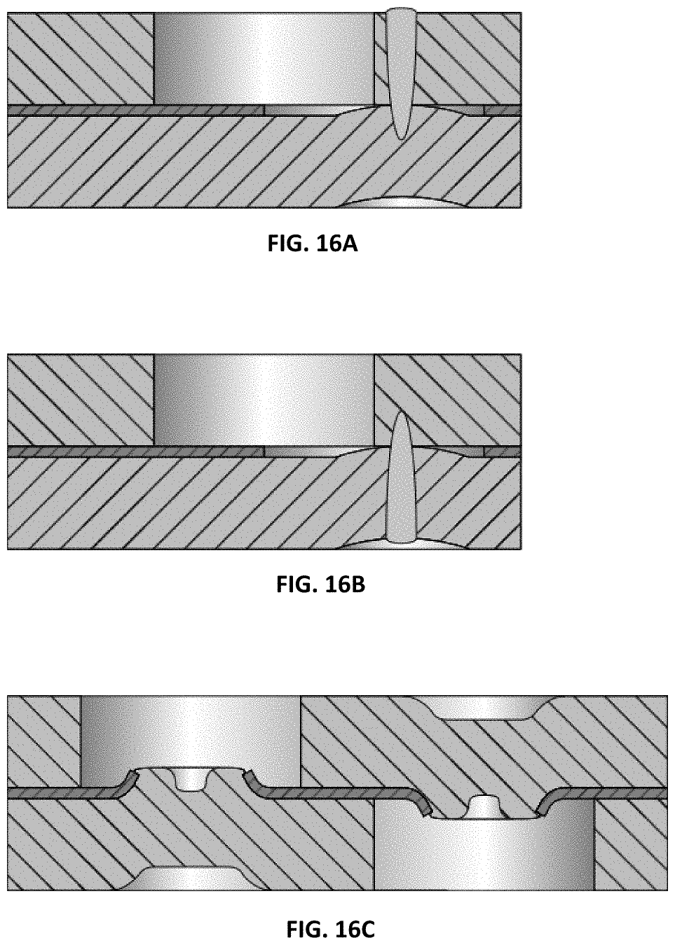

Further, the inter-layer mechanical tacking to help fix the first, second and third conductive layers may be implemented in a variety of ways. In FIG. 16A, tacking and application of the brazing material are implemented from the same direction (or from the same side as the layer stack), while in FIG. 16B illustrates a scenario where tacking and application of the brazing material are implemented in opposite directions (or from opposite sides of the layer stack). FIG. 16C illustrates another alternative embodiment whereby tacking and application of the brazing material are implemented alternately from different directions (or sides of the layer stack).

Any numerical range described herein with respect to any embodiment of the present invention is intended not only to define the upper and lower bounds of the associated numerical range, but also as an implicit disclosure of each discrete value within that range in units or increments that are consistent with the level of precision by which the upper and lower bounds are characterized. For example, a numerical distance range from 7 nm to 20 nm (i.e., a level of precision in units or increments of ones) encompasses (in nm) a set of [7, 8, 9, 10, . . . , 19, 20], as if the intervening numbers 8 through 19 in units or increments of ones were expressly disclosed. In another example, a numerical percentage range from 30.92% to 47.44% (i.e., a level of precision in units or increments of hundredths) encompasses (in %) a set of [30.92, 30.93, 30.94, . . . , 47.43, 47.44], as if the intervening numbers between 30.92 and 47.44 in units or increments of hundredths were expressly disclosed. Hence, any of the intervening numbers encompassed by any disclosed numerical range are intended to be interpreted as if those intervening numbers had been disclosed expressly, and any such intervening number may thereby constitute its own upper and/or lower bound of a sub-range that falls inside of the broader range. Each sub-range (e.g., each range that includes at least one intervening number from the broader range as an upper and/or lower bound) is thereby intended to be interpreted as being implicitly disclosed by virtue of the express disclosure of the broader range.

The forgoing description is provided to enable any person skilled in the art to make or use embodiments of the invention. It will be appreciated, however, that the invention is not limited to the particular formulations, process steps, and materials disclosed herein, as various modifications to these embodiments will be readily apparent to those skilled in the art. That is, the generic principles defined herein may be applied to other embodiments without departing from the spirit or scope of the embodiments of the invention.

What is claimed is:

1. A method of fabricating a multi-layer contact plate, comprising:
providing a layer stack with first, second and third conductive layers, the second conductive layer being at least partially sandwiched between the first and third conductive layers, the layer stack including a gap through which the third conductive layer is partially exposed via an overlap between a first hole in the first conductive layer and a second hole in the second conductive layer;
inserting brazing material into the first and second holes in the first and second conductive layers; and
brazing the layer stack after the inserting.

2. The method of claim 1, further comprising:
denting a section of the third conductive layer that is aligned with the second hole in the second conductive layer at least partially outside of the gap to reduce a distance between the first and third conductive layers.

3. The method of claim 2, wherein the denting places part of the first conductive layer in direct contact with a dented part of the third conductive layer.

4. The method of claim 1,
wherein the first hole in the first conductive layer completely overlaps the second hole in the second conductive layer, or
wherein the first hole in the first conductive layer partially overlaps the second hole in the second conductive layer.

5. The method of claim 1, wherein the brazing is an electrical brazing based on a current applied to the layer stack.

6. The method of claim 1, further comprising:
inserting one or more inter-layer mechanical tacks between two or more of the first, second and third conductive layers.

7. The method of claim 1,
wherein the first and third conductive layers comprise aluminum,
wherein the second conductive layer comprises steel, and
wherein the first and third conductive layers are each thicker than the second conductive layer.

8. The method of claim 1, wherein the first hole in the first conductive layer and the second hole in the second conductive layer are offset from each other.

9. The method of claim 1, wherein the third conductive layer includes a third hole that overlaps at least partially with both the first and second holes.

10. The method of claim 1,
wherein the first hole and the second hole are different sizes, or
wherein the first hole and the second hole are the same size while being offset from each other.

11. A multi-layer contact plate, comprising:
a layer stack with first, second and third conductive layers, the second conductive layer being at least partially sandwiched between the first and third conductive layers,
wherein the first, second and third conductive layers are mechanically and/or electrically connected to each other via a set of inter-layer connections,
wherein at least one inter-layer connection among the set of inter-layer connections includes a brazed area where the second conductive layer is brazed to each of the first and third conductive layers, and
wherein the brazed area is defined inside of first and second holes of the first and second conductive layers, respectively, the first and second holes overlapping at least in part.

12. The multi-layer contact plate of claim 11, where the first and third conductive layers are directly brazed to each other through the second hole in the second conductive layer.

13. The multi-layer contact plate of claim 11, further comprising:
one or more mechanical tacks are arranged between two or more of the first, second and third conductive layers.

14. The multi-layer contact plate of claim 11,
wherein the first and third conductive layers comprise aluminum,
wherein the second conductive layer comprises steel, and
wherein the first and third conductive layers are each thicker than the second conductive layer.

15. The multi-layer contact plate of claim 11, wherein the first and third conductive layers are in direct contact with each other through the second hole in the second conductive layer at part of the brazed area.

16. The multi-layer contact plate of claim 15, wherein a part of the third conductive layer that contacts the first conductive layer is dented.

17. The multi-layer contact plate of claim 11,
wherein the set of inter-layer connections includes a first subset of inter-layer connections and a second subset of inter-layer connections, and
wherein the first subset of inter-layer connections is associated with higher electrical resistance as compared to the second subset of inter-layer connections.

18. The multi-layer contact plate of claim 11, wherein the first hole in the first conductive layer and the second hole in the second conductive layer are offset from each other.

19. The multi-layer contact plate of claim 11, wherein the first hole and the second hole are different sizes.

20. The multi-layer contact plate of claim 11, wherein the first hole and the second hole are the same size while being offset from each other.
